(19) United States
(12) Patent Application Publication
(10) Pub. No.: US 2020/0410512 A1
(43) Pub. Date: Dec. 31, 2020

(54) MARKETING ANALYTICS SYSTEM

(71) Applicant: Miriam SCOTT, Broadbeach (AU)

(72) Inventor: Miriam SCOTT, Broadbeach (AU)

(21) Appl. No.: 16/709,904

(22) Filed: Dec. 10, 2019

(30) Foreign Application Priority Data
Jun. 27, 2019 (AU) 2019902262

(51) Int. Cl. G06Q 30/02

(52) U.S. Cl. CPC G06Q 30/0201; G06Q 30/0243; G06Q 30/0273; G06Q 30/0276; G06Q 30/0247

(57) ABSTRACT

A marketing analytics system including a software program for processing marketing data, a server for communicating with the software program via the internet and hosting the data collected by the software program. The software program is adapted to automatically issue reference codes for different marketing campaigns, so that the effectiveness of the campaign can be automatically analyzed on the software program.

### TECHNICAL FIELD

The present invention relates to the marketing industry and, more particularly to a software program for enabling business proprietors to analyze marketing information.

### BACKGROUND

Business proprietors have to carefully allocate their marketing budget to avoid cash flow problems. Some advertising mediums are more effective than others, generating a higher return on investment. However, it is difficult for business proprietors to identify the most effective advertisement medium overall or for any particular campaign.

Many hours could be spent on a particular advertising medium, which is not effective for the business. Likewise, many hours could be spent manually calculating the effectiveness of a campaign, which detracts from the hours that could be spent operating the business.

The marketing analysis performed manually may not be accurate, due to human error. Ensuring that the marketing data is accurately captured can be an onerous and time-consuming process. Business proprietors often have to train and check that their staff have not forgotten to capture the data. Some staff members can choose to deliberately disobey the orders of a business proprietor to capture the marketing data in order to sabotage the business.

If the analysis is not accurately performed, too much money could be spent on any one advertising medium which does not deliver an effective return on investment.

If a business proprietor is running multiple different campaigns on one or more platforms, it can be difficult, if not impossible, to practically calculate the effectiveness of any one of those individual campaigns. Nevertheless, it can be critical to assess which campaign was the most effective so that more budget can allocated to repeating successful campaigns.

Advertising agents may provide data to a business proprietor which suggests that a marketing campaign will have a particular reach, but that marketing platform may not comprise the target audience of the business. Many marketing agents can make promises, but the effectiveness of the marketing campaign may not be able to be measured accurately.

Many business proprietors simply develop a subjective feeling of what is the most effective advertising platform and/or campaign for their business. However, that feeling could be incorrect and they do not have objective data to verify their feeling.

It would be advantageous if there was a way to objectively and automatically calculate the exact return on investment for any particular marketing campaign.

The object of the present invention is to overcome or at least substantially ameliorate the aforementioned problems.

### SUMMARY OF THE INVENTION

According to the present invention, there is provided a marketing analytics system comprising:
(a) a software program for processing marketing data; and
(b) a server for communicating with the software program via the internet and hosting the data collected by the software program;
wherein the software program is adapted to automatically issue reference codes for different marketing campaigns, so that the effectiveness of the campaign can be automatically analyzed on the software program.

Preferably, the software program is adapted to automatically calculate:
(a) the revenue per marketing campaign;
(b) the profit per marketing campaign;
(c) the amount of customers per marketing campaign;
(d) the profit per customer per marketing campaign;
(e) the marketing revenue per customer;
(f) periodic marketing data; and/or
(g) revenue from one marketing campaign compared to another.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a representation of a tablet computer showing an exemplary advertisement for use with the system of the present invention.

FIG. 2 is a representation of the tablet computer of FIG. 1 showing a point of sale interface according to an embodiment of the present invention.

FIG. 3 is a representation of the tablet computer of FIG. 1 showing a campaign comparison report according to an embodiment of the present invention.

### DETAILED DESCRIPTION

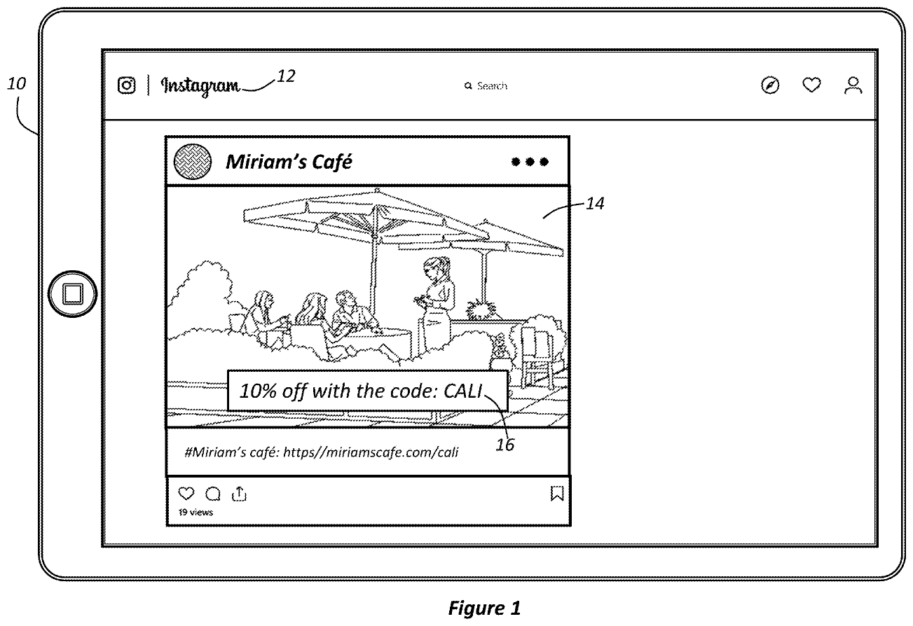

FIG. 1 shows a tablet computer 10 running a social media webpage 12 (in this case, it is an Instagram™ page). The webpage 12 shows an advertisement 14 for a café, which mentions a discount of 10% if the reference code 16 (which, in this case, is the word “Cali”) in the advertisement is presented to the cashier of the café. The reference codes may also be QR codes, numbers, letters or barcodes, for example.

The advertisement is in electronic form in the embodiment of the invention shown in FIG. 1. However, advertisements bearing the codes according to the present invention could also be provided in any form, including paper or audio form.

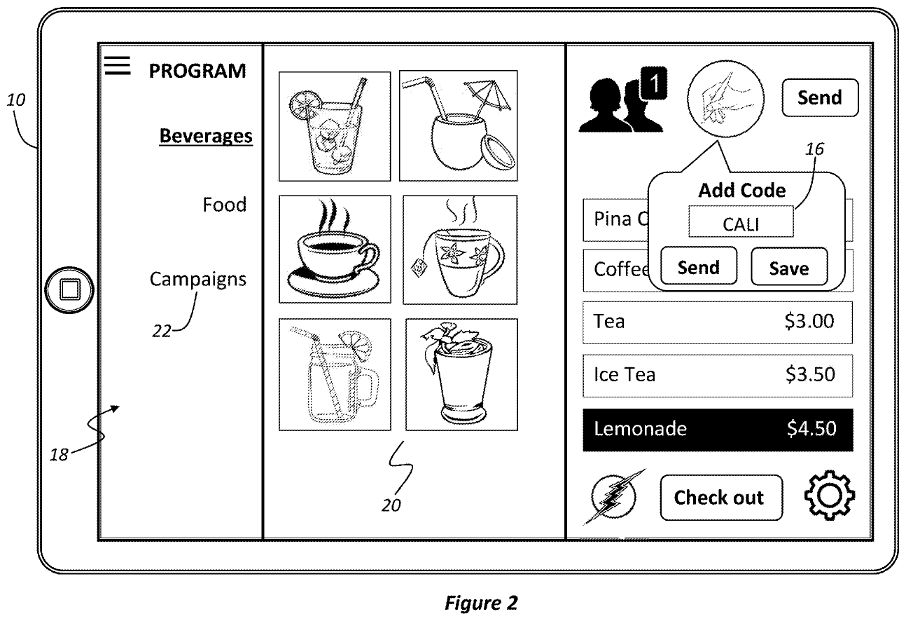

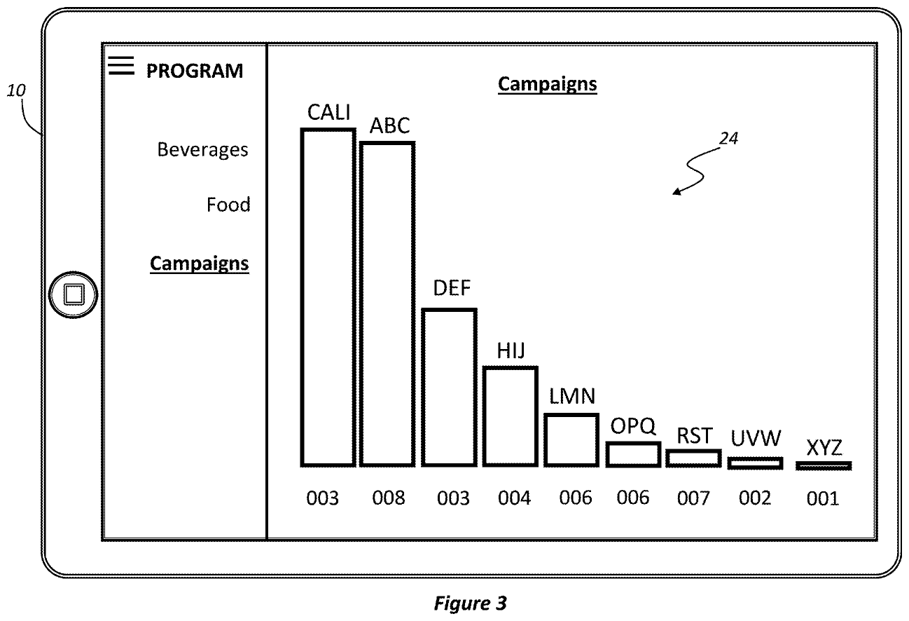

The customer then presents to the café, purchases the goods and then provides the reference code to the cashier. The system of the present invention includes a software program for a point of sale terminal, as shown in FIGS. 2 and 3.

With reference to FIG. 2, the software program allows the cashier to input the reference code 16 into the system using the transaction interface 18 when processing the transaction for any particular item 20. The reference code 16 relates to a particular advertising campaign.

A user of the software program of the present invention can access the results of each campaign by selecting the campaigns icon 22 on the transaction interface 18 (see FIG. 2). This takes the user to the campaign comparison report 24 shown in FIG. 3, which shows the results of each advertising campaign for the business proprietor.

The user can then view the results of any particular campaign by selecting the bar graph for that campaign. The software automatically calculates and provides the following data:
(a) the revenue per marketing campaign;
(b) the profit per marketing campaign;
(c) the amount of customers per marketing campaign;
(d) the profit per customer per marketing campaign;
(e) the marketing revenue per customer;
(f) periodic marketing data; and/or
(g) revenue from one marketing campaign compared to another.

The software program is adapted to automatically provide marketing reports periodically. These reports can be shared amongst the proprietors of the business to assist them to make strategic decisions for the business.

The program of the present invention which runs on the tablet computer (functioning as a point of sale terminal) communicates with a remote server (in the cloud), where the data is computed and stored. The program of the present invention can run as a stand-alone application on the computer of the user, but it can also be accessed online via the cloud.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A marketing analytics system comprising:
(a) a software program for processing marketing data; and
(b) a server for communicating with the software program via the internet and hosting the data collected by the software program;
wherein the software program is adapted to automatically issue reference codes for one or more marketing campaigns, so that the effectiveness of the one or more marketing campaigns can be automatically analyzed on the software program.

2. The system of claim 1, wherein the software program is further adapted to automatically calculate the revenue per marketing campaign.

3. The system of claim 1, wherein the software program is further adapted to automatically calculate the profit per marketing campaign.

4. The system of claim 2, wherein the software program is further adapted to automatically calculate the profit per marketing campaign.

5. The system of claim 1, wherein the software program is further adapted to automatically calculate a number of customers per marketing campaign.

6. The system of claim 1, wherein the software program is further adapted to automatically calculate the profit per customer per marketing campaign.

7. The system of claim 1, wherein the software program is further adapted to automatically calculate the marketing revenue per customer.

8. The system of claim 1, wherein the software program is further adapted to automatically provide marketing reports periodically.

9. The system of claim 1, wherein the software program is further adapted to automatically calculate the cost of any one or more marketing campaigns.

10. The system of claim 1, wherein the software program is further adapted to automatically compare marketing campaigns.
